(19) United States
(12) Patent Application Publication
(10) Pub. No.: US 2007/0244006 A1
(43) Pub. Date: Oct. 18, 2007

(54) Fungicidal Mixtures

(76) Inventors: Jordi Tormo i Blasco, Laudenbach (ES); Thomas Grote, Wachenheim (DE); Maria Scherer, Godramstein (DE); Reinhard Stierl, Freinshiem (DE); Siegfried Strathmann, Limburgerhof (DE); Ulrich Schofl, Bruhl (DE); Wilhelm Rademacher, Limburgerhof (DE)

Correspondence Address: BIRCH STEWART KOLASCH & BIRCH, PO BOX 747, FALLS CHURCH, VA, 22040-0747, US

(21) Appl. No.: 11/579,959

(22) PCT Filed: May 11, 2005
(86) PCT No.: PCT/EP05/05073

§ 371 Date: Nov. 9, 2006

(30) Foreign Application Priority Data
May 13, 2004 (DE) 102004024194.5

(51) Int. Cl. A01N 43/90; A01N 25/26; A01N 25/34; A01N 43/40; A01N 43/647

(52) U.S. Cl. 504/100; 514/259.31

(57) ABSTRACT

Fungicidal mixtures comprising, as active components,
1) a triazolopyrimidine derivative of the formula I, 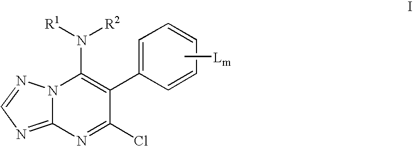 in which the variables are as defined below:
R¹ is alkyl, haloalkyl or alkenyl;
R² is hydrogen or one of the groups mentioned for R¹;
R¹ and R² together may also form a straight-chain or branched alkylene chain; L is fluorine, chlorine or bromine; m is 2 or 3; and 2) one or more inhibitors of gibberellin biosynthesis (II) and/or auxin transport (III); in a synergistically effective amount, methods for controlling harmful fungi using mixtures of compounds of the formula I with inhibitors II and/or III by using the mixtures according to the invention and the use of the compound I with inhibitors II and/or III for preparing such mixtures, and also compositions comprising these mixtures.

The present invention relates to fungicidal mixtures comprising, as active components,

1) a triazolopyrimidine derivative of the formula I, 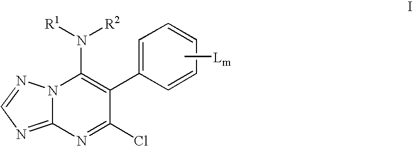
in which the variables are as defined below:
R¹ is C₁-C₆-alkyl, C₁-C₆-haloalkyl or C₃-C₆-alkenyl;
R² is hydrogen or one of the groups mentioned for R¹;
R¹ and R² together may also form a straight-chain or branched C₃-C₈-alkylene chain;
L is fluorine, chlorine or bromine;
m is 2 or 3;

and

2) one or more inhibitors of gibberellin biosynthesis (II) and/or auxin transport (III);

in a synergistically effective amount.

Moreover, the invention relates to a method for controlling harmful fungi using mixtures of compounds of the formula I and inhibitors II and/or III by using the mixtures according to the invention and the use of the compounds I with inhibitors II and/or III for preparing such mixtures, and also to compositions comprising these mixtures.

The compounds of the formula I, their preparation and their action against harmful fungi are known from the literature (EP-A 550 113; WO 98/46607; WO 98/46608).

The inhibitors II and/or III are generally known in agriculture as growth regulators. They relate in particular to active compounds from the groups:
acylcyclohexanedione compounds of the formula IIa 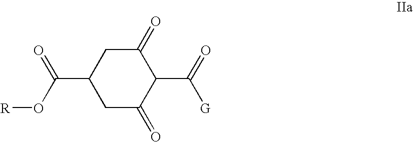
in which
R is hydrogen, C₁-C₈-alkyl, C₁-C₈-alkylthioalkyl or phenyl which is unsubstituted or substituted by one to three groups R^{a} and
   R^{a} is halogen, nitro, cyano, amino, C₁-C₈-alkyl, C₁-C₄-haloalkyl, C₁-C₈-alkoxy or C₁-C₄-haloalkoxy,
G is C₁-C₈-alkyl, C₃-C₆-cycloalkyl, benzyl which is unsubstituted or substituted in the ring system by one to three groups R^{a}, is phenethyl, phenoxymethyl, 2-thienylmethyl, C₁-C₈-alkoxymethyl or C₁-C₈-alkylthiomethyl steht,
and agriculturally tolerable salts thereof;
triazolyls (IIb) as inhibitors of cytochrome P-450-dependent monooxygenases whose principal action is to block the metabolism of gibberellins, such as paclobutrazol (IIb.1) or uniconazole (IIb.2);
quaternary ammonium compounds (IIc) which inhibit early reactions in gibberellin biosynthesis, in particular chlormequat chloride (IIc.1), mepiquat chloride (IIc.2) and mepiquat pentaborate (IIc.3);
and also
inhibitors of auxin transport (III), in particular 2-{1-[4-(3,5-difluorophenyl)semicarbazono]ethyl}nicotinic acid, common name diflufenzopyr (III.1).

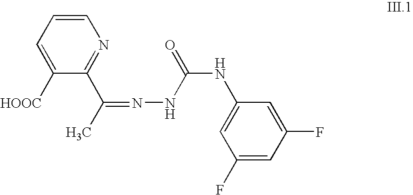

In modern agriculture, the efficacy of fungicides is still hampered by the following problems:
unsatisfactory action against individual parasite species which are generally less sensitive to certain active compounds;
unsatisfactory action against individual pathogen strains which have developed resistance against or tolerance to certain fungicidally active compounds;
unsatisfactory action against attack by harmful fungi, owing to excessively low penetration of the crop stand with fungicide spray mist.

In many cases, the tolerance or resistance of harmful fungi to fungicides is the result of an incomplete application of fungicides. Especially in dense crop stands or in dense crowns of fruit trees, treatment by spraying or atomizing does not reach the inner regions of the stands or individual plants, or only reaches them in part. As a result, there are areas which are not or only partially protected against fungal attack. In the latter case, there is the risk that strains of harmful fungi are formed and then widely propagate which are tolerant or resistant to the fungicides employed, which massively reduces the benefit of such agents.

Accordingly, it was an object of the invention to provide active compound combinations having improved action against harmful fungi, reducing the probability of the harmful fungi becoming tolerant or resistant to the fungicidally active compounds.

Surprisingly, it has now been found that, by using fungicidally active compounds of the formula I and growth regulators of the formulae II and III simultaneously, it is much easier to prevent plant damage caused by pathogens in a large number of agricultural and horticultural crop plants than by a fungicide treatment only with compounds of the formula I. Moreover, it has been found that simultaneous, that is joint or separate, application of the compound I and the inhibitors II/III or sequential application of the compound I and the inhibitors II/III allows better control of harmful fungi than the individual compounds (synergistic mixtures). The direct result are increased yields combined with a better quality of the harvested material.

The inhibitors II and III mentioned, their preparation and their action are known per se from the prior art:

prohexadione, usually employed in the form of an alkali metal or alkaline earth metal salt, in particular as calcium salt: prohexadione-Ca (IIa.1): EP-A 123 001;

trinexapac, usually employed as ester or salt; in particular as the ethyl ester: trinexapac-ethyl (IIa.2): EP-A 126 713;

paclobutrazol (IIb.1): Proc. Br. Crop Prot. Conf.—Weeds, 1982, Vol.1, p. 3;

uniconazole (IIb.2): Plant Cell Physiol., 1984, Vol. 25, p. 611;

chlormequat, usually employed in the form of a salt, such as the chloride: chlormequat chloride (IIc.1): US 3 156 554; DE 11 99 048;

mepiquat, usually employed in the form of a salt, such as the chloride: mepiquat chloride (IIc.2) or pentaborate: mepiquat pentaborate (IIc.3): U.S. Pat. No. 3,905,798; DE 22 07 575.

diflufenzopyr (III.1), is frequently also employed in the form of a salt, such as the sodium salt: Proc. Br. Crop Prot. Conf.—Weeds, 1999, Vol.1, p. 35.

Particularly suitable growth regulators are acylcyclohexanediones of the formula IIa, such as prohexadione-Ca (IIa.1) or trinexapac-ethyl (IIa.2), since, in addition to their morphoregulatory action, they are also able to protect crop plants against biotic and abiotic stressors [cf.: EP-A 123 001, page 27, lines 20 and 21 (for prohexadione and related substances) or for trinexapac-ethyl and related compounds in EP-A 126 713]. The induction of resistance by the compounds mentioned against certain pathogens is known from Bazzi et al. (European Journal of Horticultural Science 68; pp. 108-114; pp. 115-122).

The use of diflufenzopyr of the formula III.1 optimizes not only the efficacy of fungicides but also leads to an increased yield in useful plants (WO 01/43544).

Fungicidal mixtures of 5-chlorotriazolopyrimidines with fungicidally active compounds are known in a general manner from EP-A 988 790 and U.S. Pat. No. 6,268,371.

Suitable for the mixtures according to the invention are in particular those compounds of the formula I in which R¹ and R² together form a straight-chain or branched C₃-C₈-alkylene chain. These compounds correspond to formula I.1,

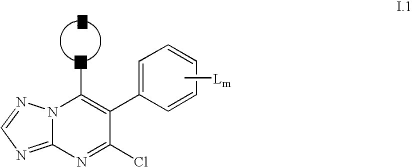

where D is a straight-chain or branched C₃-C₈-alkylene chain, in particular a branched C₅-alkylene chain, such as 3-methylpentylene.

Preference is likewise given to compounds of the formula I in which the substituted 6-phenyl group is a 2,4,6-trifluorophenyl ring. These compounds correspond to formula I.2,

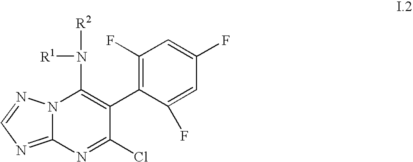

where R¹ and R² are as defined for formula I.

In addition, the invention also preferably provides the following embodiment of the compounds of the formula I:

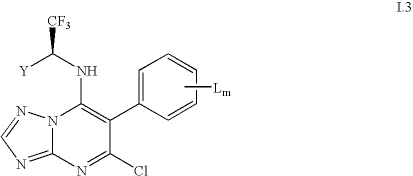

In formula I.3, Y is hydrogen or methyl.

Particular preference is given to the following compounds of the formula I:

| No. | R¹ | R² | Lₘ |
|---|---|---|---|
| I-1 | —CH₂CH₂CH(CH₃)CH₂CH₂— | | 2,4,6-F₃ |
| I-2 | —CH₂CH₂CH(CH₃)CH₂CH₂— | | 2-F,6-Cl |
| I-3 | (S)CH(CH₃)CF₃ | H | 2,4,6-F₃ |

The compound I-1, 5-chloro-7-(4-methylpiperidin-1-yl)-6-(2,4,6-trifluorophenyl)-[1,2,4]triazolo[1,5-a]pyrimidine is especially preferred for use in the mixtures according to the invention.

The mixtures of the compound I and the inhibitors II and/or III or the simultaneous, that is joint or separate, use of the compound I and the inhibitors II and/or III are distinguished by being highly active against a wide range of phytopathogenic fungi, in particular from the classes of the Ascomycetes, Deuteromycetes, Oomycetes and Basidiomycetes. They can be used in crop protection as foliar fungicides, as fungicides for seed dressing and as soil-acting fungicides.

They are particularly important for controlling a multitude of fungi on various cultivated plants, such as bananas, cotton, vegetable species (for example cucumbers, beans and cucurbits), barley, grass, oats, coffee, potatoes, corn, fruit species, rice, rye, soybeans, tomatoes, grapevines, wheat, ornamental plants, sugar cane and on a large number of seeds.

They are particularly suitable for the control of the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria species on wheat, Botrytis cinerea on strawberries, vegetables, ornamental plants and grapevines, Mycosphaerella species on bananas, peanuts and cereals, Pseudocercosporella herpotrichoides on wheat and barley, Pyricularia oryzae on rice, Phakopsora species on soybeans, Phytophthora infestans on potatoes and tomatoes, Pseudoperonospora species on cucurbits and hops, Plasmopara viticola on grapevines, Alternaria species on fruit and vegetables and also Fusarium and Verticillium species.

Particularly advantageously, they are suitable for the treatment of lignescent plants (in particular fruit species and grapevines), and also seedlings (vegetables and strawberries from the families of the Solanaceae and Rosaceae) and ornamental plants.

The compound I and the inhibitors II and/or III can be applied simultaneously, that is jointly or separately, or in succession, where, in the case of separate application, the inhibitors II and/or III are preferably applied first.

When preparing the mixtures, it is preferred to employ the pure active compounds I and II/III, to which further active compounds against harmful fungi or against other pests, such as insects, arachnids or nematodes, or else herbicidal or growth-regulating active compounds or fertilizers can be added according to need.

Other suitable active compounds in the above sense are in particular fungicides selected from the following groups:
acylalanines, such as benalaxyl, metalaxyl, ofurace, oxadixyl,
amine derivatives, such as aldimorph, dodine, dodemorph, fenpropimorph, fenpropidin, guazatine, iminoctadine, spiroxamine, tridemorph,
anilinopyrimidines, such as pyrimethanil, mepanipyrim or cyprodinil,
antibiotics, such as cycloheximid, griseofulvin, kasugamycin, natamycin, polyoxin or streptomycin,
azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol, triticonazole,
dicarboximides, such as iprodione, myclozolin, procymidone, vinclozolin,
dithiocarbamates, such as ferbam, nabam, maneb, mancozeb, metam, metiram, propineb, polycarbamate, thiram, ziram, zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolan, mepronil, nuarimol, penthiopyrad, picobenzamid, probenazole, proquinazid, pyrifenox, pyroquilon, quinoxyfen, silthiofam, thiabendazole, thifluzamid, thiophanate-methyl, tiadinil, tricyclazole, triforine,
copper fungicides, such as Bordeaux mixture, copper acetate, copper oxychloride, basic copper sulfate,
nitrophenyl derivatives, such as binapacryl, dinocap, dinobuton, nitrophthalisopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin acetate, fenoxanil, ferimzone, fluazinam, fosetyl, fosetyl-aluminum, iprovalicarb, hexachlorobenzene, mandipropamid, metrafenone, pencycuron, propamocarb, phosphorous acid, phthalide, toloclofos-methyl, quintozene, zoxamide,
strobilurins, such as azoxystrobin, dimoxystrobin, enestroburin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet, tolylfluanid,
cinnamides and analogous compounds, such as dimethomorph, flumetover or flumorph.

In one embodiment of the mixtures according to the invention, a further fungicide IV or two fungicides IV and V are added to the compounds I and II/III.

Preference is given to mixtures of the compounds I and II/III and a component IV. Particular preference is given to mixtures of the compounds I and II or III.

What is usually used are mixtures of a compound I with an inhibitor II or III. In certain cases, however, mixtures of a compound with two or more inhibitors II and/or III may be advantageous.

The compound I and the inhibitors II are usually applied in a weight ratio of from 100:1 to 1:100, preferably from 20:1 to 1:20, in particular from 10:1 to 1:10. The compound I and the inhibitors III, in particular the compound III.1, are usually applied in a weight ratio of from 1000:1 to 1:1, preferably from 200:1 to 20:1.

The components IV and, if appropriate, V are, if desired, added in a ratio of from 20:1 to 1:20 to the compound I.

Depending on the type of compound and the desired effect, the application rates of the mixtures according to the invention are from 5 g/ha to 1000 g/ha, preferably 50 to 900 g/ha, in particular 50 to 750 g/ha.

Correspondingly, the application rates for the compound I are generally from 1 to 1000 g/ha, preferably from 10 to 900 g/ha, in particular from 20 to 750 g/ha.

Correspondingly, the application rates for the inhibitors II are generally from 1 to 1000 g/ha, preferably from 10 to 900 g/ha, in particular from 40 to 750 g/ha.

Correspondingly, the application rates for the inhibitors III, in particular the compound III.1, are generally from 0.01 to 50 g/ha, preferably from 0.1 to 10 g/ha.

In the treatment of seed, application rates of mixture are generally from 1 to 1000 g/100 kg of seed, preferably from 1 to 750 g/100 kg, in particular from 5 to 500 g/100 kg.

The method for controlling harmful fungi is carried out in agricultural crops by the separate or joint application of the compound I and the inhibitors II and/or III or of the mixtures of the compound I and the inhibitors II and/or III, by spraying or dusting the seeds, the plants or the soils before or after sowing of the plants or before or after emergence of the plants. In permanent crops such as fruit trees or grapevines, the treatment is preferably carried out before or during the annual growth phase.

The mixtures according to the invention, or the compounds I and II/III, can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably from 95% to 100% (according to NMR spectrum).

The following are examples of formulations: 1. Products for dilution with water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturrax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and prepared as water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersants, wetters and silica gel. Dilution with water gives a stable dispersion or solution of the active compound.

2. Products to be Applied undiluted

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and associated with 95.5% carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents are typically admixed with the compositions according to the invention in a weight ratio of from 1:10 to 10:1.

The compounds I and II/III or the mixtures or the corresponding formulations are applied by treating the harmful fungi, the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal effect of the compound and the mixtures can be demonstrated by the following tests:

The active compounds, separately or jointly, were prepared as a stock solution comprising 0.25% by weight of active compound in acetone or DMSO. 1% by weight of the emulsifier Uniperol® EL (wetting agent having emulsifying and dispersant action based on ethoxylated alkylphenols) was added to this solution, and the mixture was diluted with water to the desired concentration.

### USE EXAMPLE 1

### Activity Against Scab on Apple Leaves Caused by Venturia inaequalis, Protective Application

Leaves of apples were sprayed to runoff point with an aqueous suspension having the concentration of active compound stated below. After 12 days, the treated plants were inoculated with an aqueous spore suspension of Venturia inaequalis. The apples were then initially placed in a water-vapor-saturated chamber at 24° C. for 48 hours and then in a greenhouse at temperatures between 20 and 24° C. for 20 days. The extent of the development of the infection on the upper sides of the leaves was then determined visually.

The visually determined percentages of infected leaf areas were converted into efficacies in % of the untreated control:

The efficacy (E) is calculated as follows using Abbot's formula:
E=(1−α/β)−100

α corresponds to the fungal infection of the treated plants in % and

β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of mixtures of active compounds were determined using Colby's formula (Colby, S. R. “Calculating synergistic and antagonistic responses of herbicide Combinations”, Weeds, 15, 20-22, 1967) and compared with the observed efficacies.

Colby's formula:
E=x+y−x·y/100

E expected efficacy, expressed in % of the untreated control, when using the mixture of the active compounds A and B at the concentrations a and b

x efficacy, expressed in % of the untreated control, when using the active compound A at the concentration a

y efficacy, expressed in % of the untreated control, when using the active compound B at the concentration b

TABLE A
Individual active compounds

| | | Concentration of | |
|---|---|---|---|
| | | active compound | Efficacy in % |
| | Active compound/ | in the spray | of the untreated |
| Example | Mixing ratio | liquor [ppm] | control |
| 1 | control (untreated) | — | (92% infection) |
| 2 | I-1 | 50 | 48 |
| | | 25 | 18 |
| 3 | prohexadione-Ca (IIa.1) | 100 | 29 |
| | | 50 | 4 |

TABLE B
Mixtures according to the invention

| | Mixture of active | | |
|---|---|---|---|
| | compounds | | |
| | Concentration | Observed | Calculated |
| Example | Mixing ratio | efficacy | efficacy*) |
| 4 | I-1 + IIa.1 | 73 | 50 |
| | 50 + 50 ppm | | |
| | 1:1 | | |
| 5 | I-1 + IIa.1 | 78 | 63 |
| | 50 + 100 ppm | | |
| | 1:2 | | |
| 6 | I-1 + IIa.1 | 73 | 42 |
| | 25 + 100 ppm | | |
| | 1:4 | | |

*)calculated efficacy using Colby's formula

### USE EXAMPLE 2

### Activity Against Peronospora of Grapevines Caused by Plasmopara viticola, 9 Day Protective Application

Leaves of potted vines were sprayed to runoff point with an aqueous suspension having the concentration of active compound stated below. To be able to assess the persistency of the substances, the plants were, after the spray coating had dried on, placed in a greenhouse for 9 days. Only then were the leaves inoculated with an aqueous zoospore suspension of Plasmopara viticola. The grapevines were then initially placed in a water-vapor-saturated chamber at 24° C. for 48 hours and then in a greenhouse at temperatures between 20 and 30° C. for 5 days. After this time, the plants were again placed in a humid chamber for 16 hours, to promote sporangiophore eruption. The extent of the development of the infection on the undersides of the leaves was then determined visually.

Evaluation was carried out analogously to example 1.

TABLE C
Individual active compounds

| | | Concentration of | |
|---|---|---|---|
| | | active compound | Efficacy in % |
| | Active compound/ | in the spray | of the untreated |
| Example | Mixing ratio | liquor [ppm] | control |
| 7 | control (untreated) | — | (80% infection) |
| 8 | I-1 | 50 | 25 |
| | | 25 | 13 |
| 9 | Prohexadione-Ca (IIa.1) | 100 | 0 |
| | | 50 | 0 |

TABLE D
Mixtures according to the invention

| | Mixture of active | | |
|---|---|---|---|
| | compounds | | |
| | Concentration | Observed | Calculated |
| Example | Mixing ratio | efficacy | efficacy*) |
| 10 | I-1 + IIa.1 | 63 | 25 |
| | 50 + 50 ppm | | |
| | 1:1 | | |
| 11 | I-1 + IIa.1 | 75 | 25 |
| | 50 + 100 ppm | | |
| | 1:2 | | |
| 12 | I-1 + IIa.1 | 69 | 13 |
| | 25 + 100 ppm | | |
| | 1:4 | | |

*)calculated efficacy using Colby's formula

### USE EXAMPLE 3

### Activity Against Net Blotch of Barley Caused by Pyrenophora teres, 1 Day Protective Application

Leaves of potted barley seedlings of the cultivar “Hanna” were sprayed to runoff point with an aqueous suspension having the concentration of active compound stated below. 24 hours after the spray coating had dried on, the test plants were inoculated with an aqueous spore suspension of Pyrenophora [syn. Drechslera] teres, the net blotch pathogen. The test plants were then placed in a greenhouse at temperatures between 20 and 24° C. and at 95 to 100% relative atmospheric humidity. After 6 days, the extent of the development of the disease was determined visually in % infection of the entire leaf area.

Evaluation was carried out analogously to example 1.

TABLE E
Individual active compounds

| | | Concentration of | |
|---|---|---|---|
| | | active compound | Efficacy in % |
| | Active compound/ | in the spray | of the untreated |
| Example | Mixing ratio | liquor [ppm] | control |
| 13 | control (untreated) | — | (89% infection) |
| 14 | I-1 | 3.1 | 66 |
| 15 | chlormequat chloride | 3.1 | 0 |
| | (IIc.1) | 6.3 | 0 |
| 16 | diflufenzopyr (III.1) | 0.031 | 0 |

TABLE F
Mixtures according to the invention

| | Mixture of active | | |
|---|---|---|---|
| | compounds | | |
| | Concentration | Observed | Calculated |
| Example | Mixing ratio | efficacy | efficacy*) |
| 17 | I-1 + IIc.1 | 83 | 66 |
| | 3.1 + 3.1 ppm | | |
| | 1:1 | | |
| 18 | I-1 + IIc.1 | 89 | 66 |
| | 3.1 + 6.3 ppm | | |
| | 1:2 | | |
| 19 | I-1 + III.1 | 83 | 66 |
| | 3.1 + 0.031 ppm | | |
| | 100:1 | | |

*)calculated efficacy using Colby's formula

The results show that, by virtue of strong synergism, the mixtures according to the invention are considerably more effective in all mixing ratios than had been predicted using Colby's formula.

1. A fungicidal mixture for controlling phytopathogenic harmful fungi, which mixture comprises
1) a triazolopyrimidine derivative of the formula I, 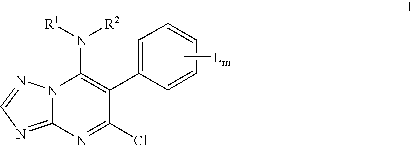
in which the variables are as defined below:
R¹ is C₁-C₆-alkyl, C₁-C₆-haloalkyl or C₃-C₆-alkenyl;
R² is hydrogen or one of the groups mentioned for R¹;
R¹ and R² together may also form a straight-chain or branched C₃-C₈-alkylene chain;
L is fluorine, chlorine or bromine;
m is 2 or 3;
and
2) one or more inhibitors of gibberellin biosynthesis (II) selected from
acylcyclohexanedione compounds of the formula Ia 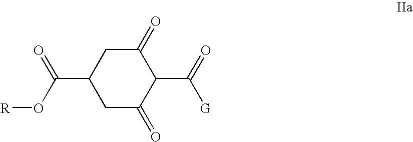
in which
R is hydrogen, C₁-C₈-alkyl, C₁-C₈-alkylthioalkyl or phenyl which is unsubstituted or substituted by one to three groups R^{a} and
R^{a} halogen, nitro, cyano, amino, C₁-C₈-alkyl, C₁-C₄-haloalkyl, C₁-C₈-alkoxy or C₁-C₄-haloalkoxy may be substituted,
G is C₁-C₈-alkyl, C₃-C₆-cycloalkyl, benzyl which is unsubstituted or substituted in the ring system by one to three groups R^{a}, is phenethyl, phenoxymethyl, 2-thienylmethyl, C₁-C₈-alkoxymethyl or C₁-C₈-alkylthiomethyl,
and agriculturally tolerable salts thereof;
triazolyls (IIb) as inhibitors of cytochrome P-450-dependent monooxygenases whose principal action is to block the metabolism of gibberellins;
quaternary ammonium compounds (llc) which inhibit early reactions in gibberellin biosynthesis;
and/or inhibitors of auxin transport (III)
in a synergistically effective amount.

2. The fungicidal mixture according to claim 1 comprising the triazolopyrimidine derivative I-1

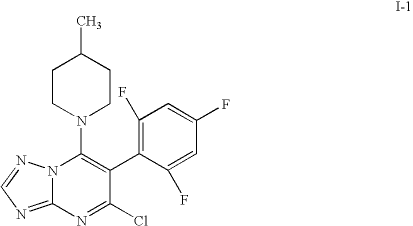

3. The fungicidal mixture according to claim 1 comprising, as inhibitor (ll), an active compound selected from the group consisting of prohexadione-Ca (IIa.1); trinexapac-ethyl (IIa.2); paclobutrazol (IIb.1); uniconazole (IIb.2); chlormequat chloride (IIc.1); mepiquat chloride (llc.2) and mepiquat pentaborate (llc.3).

4. The fungicidal mixture according to claim 1 comprising, as inhibitor (III), 2-{1-[4-(3,5-difluorophenyl)semicarbazono]ethyl}nicotinic acid, diflufenzopyr (lll.1).

5. The fungicidal mixture according to claim 1 comprising the compound of the formula I and an inhibitor II in a weight ratio of from 100:1 to 1:100.

6. The fungicidal mixture according to claim 1 comprising the compound of the formula I and an inhibitor III in a weight ratio of from 1000:1 to 1:1.

7. A composition comprising a liquid or solid carrier and a mixture according to claim 1.

8. A method for controlling phytopathogenic harmful fungi which comprises treating the fungi, their habitat or the seed, the soil or the plants to be protected against fungal attack with a synergistically effective amount of the compounds I and II and/or III according to claim 1.

9. The method according to claim 8, wherein the compounds I and II and/or III according to any of claims 1 to 4 are applied simultaneously, that is jointly or separately, or in succession.

10. The method according to claim 8, wherein the compounds I and II and/or III according to claim 1 or the mixtures according to any of claims 1 to 6 are applied in an amount of from 5 g/ha to 1000 g/ha.

11. The method according to claim 8, wherein the compounds I and II and/or III according to claim 1 or the mixtures according to any of claims 1 to 6 are applied in an amount of from 1 to 1000 g/ 00 kg of seed.

12. Seed comprising the mixture according to claim 1 in an amount of from 1 to 1000 g/100 kg.

13. The use of the compounds I and II and/or III according to claim 1 for preparing a composition suitable for controlling harmful fungi.

14. The fungicidal mixture according to claim 2 comprising, as inhibitor (ll), an active compound selected from the group consisting of prohexadione-Ca (IIa.1); trinexapac-ethyl (IIa.2); paclobutrazol (IIb.1); uniconazole (IIb.2); chlormequat chloride (IIc.1); mepiquat chloride (llc.2) and mepiquat pentaborate (llc.3).

15. The fungicidal mixture according to claim 2 comprising, as inhibitor (lIl), 2-{1-[4-(3,5 -difluorophenyl)semicarbazono]ethyl}nicotinic acid, diflufenzopyr (lll.1).

16. The fungicidal mixture according to claim 2 comprising the compound of the formula I and an inhibitor II in a weight ratio of from 100:1 to 1:100.

17. The fungicidal mixture according to claim 3 comprising the compound of the formula I and an inhibitor II in a weight ratio of from 100:1 to 1:100.

18. The fungicidal mixture according to claim 2 comprising the compound of the formula I and an inhibitor III in a weight ratio of from 1000:1 to 1:1.

19. The fungicidal mixture according to claim 4 comprising the compound of the formula I and an inhibitor III in a weight ratio of from 1000:1 to 1:1.

20. A composition comprising a liquid or solid carrier and a mixture according to claim 2.
